(19) United States
(12) Patent Application Publication
(10) Pub. No.: US 2026/0088303 A1
(43) Pub. Date: Mar. 26, 2026

(54) SOLID SUPERACID COATED ANODE FOR LITHIUM SECONDARY BATTERY AND METHOD FOR MANUFACTURING THE SAME, AND LITHIUM SECONDARY BATTERY USING THE SAME

(71) Applicant: KOREA ELECTRONICS TECHNOLOGY INSTITUTE, Seongnam-si (KR)

(72) Inventors: Sanggil WOO, Seongnam-si (KR); Je-Nam LEE, Seongnam-si (KR); Hae Ri YANG, Seongnam-si (KR)

(21) Appl. No.: 19/338,450

(22) Filed: Sep. 24, 2025

(30) Foreign Application Priority Data
Sep. 24, 2024 (KR) 10-2024-0129350

(51) Int. Cl. H01M 4/62; H01M 4/02; H01M 4/04; H01M 4/36; H01M 4/587; H01M 10/052

(52) U.S. Cl. CPC H01M 4/628; H01M 4/0404; H01M 4/0471; H01M 4/366; H01M 4/587; H01M 10/052; H01M 2004/027

(57) ABSTRACT

The present disclosure discloses an anode for a lithium secondary battery capable of improving electrochemical performance while maintaining a basic structure of an anode active material by coating a solid superacid on the anode active material, a method for manufacturing the same, and a lithium secondary battery using the same. The anode according to the present disclosures includes a current collector; and an anode material disposed on at least one surface of the current collector and including an anode active material, wherein the anode active material includes a nano-sized solid superacid present on a surface thereof.

### CROSS-REFERENCE TO RELATED APPLICATION(S)

This application claims benefit of priority to Korean Patent Application No. 10-2024-0129350 filed on Sep. 24, 2024 in the Korean Intellectual Property Office, the disclosure of which is incorporated herein by reference in its entirety.

### TECHNICAL FIELD

The present disclosure relates to an anode for a lithium secondary battery capable of improving electrochemical performance while maintaining a basic structure of an anode active material by coating a solid superacid on the anode active material, a method for manufacturing the same, and a lithium secondary battery using the same.

The project information of the present disclosure is as follows.
Project ID: 1711183891
Project No.: 2021M3H4A3A02086213
Ministry: Ministry of Science and ICT
Specialized Managing Institution: National Research Foundation of Korea
Research Project Name: Miscellaneous Projects of the Ministry of Science, ICT and Future Planning
Research Project Name:
(C) Development of 800 Wh L⁻¹-Class Cylindrical Lithium Secondary Battery Technology with Charge/Potential Utilization and Internal Stress Control for Pure Silicon Application
Project Performing Organization: Korea Electronics Technology Institute
Research Period: Jul. 26, 2021-Dec. 31, 2025

### BACKGROUND

Commercially available lithium secondary batteries primarily use graphite-based materials as anode active materials.

However, graphite-based anodes suffer from severe performance degradation under rapid charging conditions. This performance degradation poses a significant limitation on the widespread application of lithium secondary batteries, particularly in the field of electric vehicles.

The main issues with graphite-based anodes are their low lithiation potential and slow lithium-ion intercalation kinetics. During rapid charging, the slow intercalation of lithium ions induces severe polarization, leading to lithium plating on the graphite surface.

Lithium metal plating significantly reduces the capacity and cycle life characteristics of a battery, impairs cell performance, and leads to safety issues such as battery fire and explosion.

Furthermore, uneven formation of a solid electrolyte interphase (SEI) layer on the graphite surface during rapid charging accelerates lithium plating, such that capacity loss is exacerbated and safety issues are further aggravated.

Therefore, in order to improve rapid charging performance and cycle life performance, it is important to enhance intercalation kinetics of graphite and induce the formation of a stable SEI layer.

Various studies have been conducted to solve these issues.

Representative examples include controlling the graphite particle size and interlayer spacing, surface coating, and developing electrolyte solution additives. Among these, research into increasing the lithium-ion diffusion rate and enhancing the stability of the SEI layer on graphite surface has been actively conducted.

However, these approaches still have limitations that hinder their commercialization. Excessive expansion of the graphite interlayer spacing leads to the loss of Li insertion sites due to structural deformation, resulting in a decrease in reversible capacity. In addition, excessive expansion of the graphite interlayer spacing limits its application in high-energy lithium secondary batteries due to issues such as low tap density.

Although the development of new additives is effective in improving the mechanical strength and lithium-ion conductivity of the SEI, a fundamental understanding and rational design of the SEI are still lacking.

Therefore, in order to develop a graphite anode with commercial-level rapid charging capability without loss of energy density, effective surface modification research is required to improve the rapid charging characteristics and cycle life characteristics of graphite.

### SUMMARY

An aspect of the present disclosure provides an anode for a lithium secondary battery, capable of enhancing electrochemical performance by promoting the dissociation of a lithium salt and enhancing the mobility of lithium ions through the capture of anions of the lithium salt in an electrolyte via solid superacid coating on an anode active material, and a method for manufacturing the same.

Another aspect of the present disclosure provides an anode for a lithium secondary battery, capable of improving an intercalation process of lithium ions and suppressing the formation of lithium dendrites that may occur in a high current density environment, and a method for manufacturing the same.

Yet another aspect of the present disclosure provides an anode for a lithium secondary battery, capable of enhancing the electrochemical characteristics and safety of the battery by improving lithium-ion transport at an electrode-electrolyte interface, through promoting the formation of an anion-induced SEI rich in inorganic components, without modifying the electrolyte, utilizing the properties of a solid superacid, and a method for manufacturing the same.

Still yet another aspect of the present disclosure provides an anode for a lithium secondary battery, capable of reducing overvoltage in a high current density environment through the catalytic action of a solid superacid, extending charging time in a constant current (CC) mode, and enhancing the charging rate and efficiency of the battery, and a method for manufacturing the same.

The aspects of the present disclosure are not limited to the above-mentioned aspects, and other aspects and advantages of the present disclosure, which are not mentioned, can be understood from the following description and will be more clearly understood by the embodiments of the present disclosure. It will also be readily apparent that the aspects and advantages of the present disclosure can be realized by the means and combinations thereof set forth in the claims.

An anode according to the present disclosure includes a current collector; and an anode material disposed on at least one surface of the current collector and including an anode active material, wherein the anode active material includes a nano-sized solid superacid present on a surface thereof.

The solid superacid may be present on the surface of the anode active material that is in contact with an electrolyte solution.

The solid superacid has a porous structure, and may include one or more of sulfated zirconia, sulfated titanium dioxide, sulfated tin dioxide, and sulfated aluminum oxide.

The solid superacid may be included in an amount of 3 wt % or less, based on 100 wt % of the total amount of the anode active material and the solid superacid.

The solid superacid may have a diameter of 100 nm or less.

The anode active material may include a carbon-based powder.

A method for manufacturing an anode according to the present includes (a) mixing a zirconium precursor and an anode active material precursor with an organic solvent and then adding distilled water and an acidic solution thereto to perform gelation; (b) drying the gel formed by the gelation; (c) preparing an anode active material by calcining the dried powder, the anode active material including a nano-sized solid superacid coated on a surface thereof; and (d) forming an anode material by applying a slurry for the anode material containing the anode active material to at least one surface of a current collector.

In step (c), the solid superacid may be included in an amount of 3 wt % or less, based on 100 wt % of the total amount of the anode active material and the solid superacid.

The solid superacid may have a diameter of 100 nm or less.

In step (a), the organic solvent: the zirconium precursor and the anode active material precursor may be mixed with each other in a weight ratio of 1:0.01 to 0.1.

In step (a), the acidic solution may include a sulfuric acid solution.

In step (c), the calcination may be performed at 500 to 700° C. for 2 to 5 hours.

The anode active material precursor may include one or more of graphite, hard carbon, activated carbon, carbon nanotubes, carbon nanowires, carbon fibers, carbon black, porous carbon, a pyrolyzed material of cryogel, a pyrolyzed material of xerogel, and a pyrolyzed material of aerogel.

A lithium secondary battery according to the present includes an anode; a cathode, and an electrolyte, wherein the anode includes a current collector, and an anode material disposed on at least one surface of the current collector and including an anode active material, and wherein the anode active material includes a nano-sized solid superacid present on a surface thereof.

### BRIEF DESCRIPTION OF THE DRAWING

FIG. 1 shows TEM images of graphite coated with 3 wt % of a solid superacid according to the present disclosure.

FIG. 2 shows SEM images of graphite not coated with a solid superacid, and graphite coated with 1 wt %, 3 wt %, and 5 wt % of a solid superacid according to the present disclosure.

FIG. 3 shows SEM and EDS element mapping images of graphite coated with 5 wt % of a solid superacid according to the present disclosure.

FIG. 4 shows the cycle life performance and coulombic efficiency characteristics for a half-cell in which graphite not coated with a solid superacid is applied (Comparative Example) and half-cells in which graphite coated with 1 wt %, 3 wt %, and 5 wt % of a solid superacid is applied (Examples).

FIG. 5 shows SEM images after 150 cycles at a 1 C discharging rate and a 0.5 C charging rate for (b) a half-cell in which graphite not coated with a solid superacid is applied (Comparative Example) and half-cells in which graphite coated with (c) 1 wt %, (d) 3 wt %, and (e) 5 wt % of a solid superacid is applied (Examples).

FIG. 6 is a graph comparing the 80% charging time according to the charging rate for a full cell in which graphite not coated with a solid superacid is applied (Comparative Example) and a full cell in which graphite coated with 3 wt % of a solid superacid is applied (Example).

FIG. 7 is a graph comparing the cycle life performance and coulombic efficiency for a full cell in which graphite not coated with a solid superacid is applied (Comparative Example) and a full cell in which graphite coated with 3 wt % of a solid superacid is applied (Example).

### DETAILED DESCRIPTION

The aforementioned objects, features, and advantages will be described in detail below with reference to the accompanying drawings, and accordingly, those skilled in the art to which the present disclosure pertains will be able to easily implement the technical spirit of the present disclosure. In the description of the present disclosure, detailed descriptions of known technologies related to the present disclosure will be omitted if they are deemed to unnecessarily obscure the gist of the present disclosure. Hereinafter, preferred embodiments according to the present disclosure will be described in detail with reference to the accompanying drawings. In the drawings, like reference numerals indicate the same or corresponding components.

Hereinafter, it is to be understood that when any configuration is disposed “on (or under)” a component or “on an upper portion (or lower portion)” of a component, any configuration may be disposed not only in contact with the top (or bottom) surface of the component, but also other components may intervene between the component and any component disposed on (or under) the component.

In addition, it is to be understood that when a certain component is “connected,” “coupled,” or “joined” to another component, the components may be directly connected or connected to each other, but other components may “interpose” between the components, or each component may also be “connected,” “coupled,” or “joined” via other components.

Hereinafter, an anode for a solid superacid-coated anode for a lithium secondary battery, a method for manufacturing the same, and a lithium secondary battery using the same, according to some embodiments of the present disclosure, will be described.

Conventional graphite electrodes suffer from lithium metal plating on their surface due to the slow intercalation of lithium ions during rapid charging, leading to battery performance degradation and safety issues.

Furthermore, conventional graphite electrodes undergo continuous electrolyte solution decomposition due to unstable SEI layer formation, leading to capacity loss.

Conventional graphite modification techniques for graphite electrodes have employed methods such as surface coating, interlayer spacing expansion, and the development of electrolyte solution additives. However, these methods have been limited by reduced energy density and challenges in commercialization.

Accordingly, the present inventors have solved these issues by modifying the graphite surface using a solid superacid material.

In the present disclosure, the solid superacid is primarily formed on the surface of high-energy graphite.

In the present disclosure, the graphite surface is understood to include both edges and corners, which are referred to as the edge planes.

This allows for the expansion of the interlayer spacing of the surface while maintaining an original structure of the graphite, thereby promoting the diffusion into the graphite.

In addition, due to the material properties of the solid superacid, the intercalation/deintercalation kinetics of lithium ions into the graphite were increased, such that the rapid charging performance was improved. Furthermore, a stable SEI layer derived from the anions of a lithium salt was formed on the modified graphite surface, such that electrolyte solution decomposition was suppressed and cycle life characteristics were improved.

As a result, in the present disclosure, by modifying only the graphite surface using a solid superacid while maintaining a basic structure of the graphite, energy density loss may be minimized and electrochemical performance may be improved.

The anode according to the present disclosure includes a current collector, and an anode material disposed on at least one surface of the current collector and including an anode active material, wherein the anode active material includes a nano-sized solid superacid present on a surface thereof.

The current collector may be formed of a material that does not react with lithium, that is, a material that forms neither an alloy nor a compound.

The material for the current collector may include one or more of, for example, copper (Cu), stainless steel, titanium (Ti), iron (Fe), cobalt (Co), and nickel (Ni). The current collector may be formed of a single metal, such as those exemplified above, or may also be formed of an alloy or a clad material of two or more metals. The current collector is, for example, in a plate or foil shape.

The anode material includes an anode active material, wherein the anode active material preferably includes a carbon-based powder.

The carbon-based powder may include one or more of graphite, hard carbon, activated carbon, carbon nanotubes, carbon nanowires, carbon fibers, carbon black, porous carbon, a pyrolyzed material of cryogel, a pyrolyzed material of xerogel, and a pyrolyzed material of aerogel.

Preferably, the carbon-based powder may include graphite.

The anode active material of the present disclosure includes a nano-sized solid superacid present on a surface thereof.

The solid superacid has an acid strength stronger than 100% sulfuric acid, has a porous structure, and may include one or more of sulfated zirconia, sulfated tin dioxide, and sulfated aluminum oxide.

Sulfated zirconia is a zirconia particle supported by sulfuric acid, in which the surface is modified with sulfate groups (SO₄²⁻).

Sulfated tin dioxide is a tin dioxide particle supported by sulfuric acid, in which the surface is modified with sulfate groups (SO₄²⁻).

Sulfated aluminum oxide is an aluminum oxide particle supported by sulfuric acid, in which the surface is modified with sulfate groups (SO₄²⁻).

Preferably, the solid superacid may include sulfated zirconia.

In the present disclosure, by precipitating a nano-sized solid superacid on the surface of the anode active material that is in contact with the electrolyte solution, the mobility of lithium ions on the surface of the anode active material may be improved. Furthermore, by expanding the interlayer spacing on the surface of the anode active material, diffusion of lithium ions into the anode active material may be promoted, thereby facilitating the intercalation/deintercalation of lithium ions.

In addition, by inducing the formation of a stable SEI layer, the electrochemical performance of a lithium secondary battery, such as rapid charging characteristics and cycle life stability, may be improved.

The solid superacid may be included in an amount of 3 wt % or less, based on 100 wt % of the total amount of anode active material and the solid superacid. The inclusion of 3 wt % or less of the solid superacid refers to coating the surface of the anode active material with the solid superacid in an amount of 3 wt % or less.

When the solid superacid content is 3 wt % or less, the interfacial resistance of the lithium secondary battery is lowered, and rapid charging performance is improved

When the solid superacid content exceeds 3 wt %, the solid superacid may form micro-sized particles in regions other than the surface of the anode active material, which may adversely affect the performance of the lithium secondary battery.

The solid superacid may have a diameter of 100 nm or less, and preferably 50 nm or less.

When the solid superacid has a nano-sized diameter of 100 nm or less, the surface of the anode active material may be sufficiently modified to enhance reaction kinetics of the anode active material while maintaining its structure, thereby improving charging characteristics and cycle life characteristics.

The anode material may further contain a binder, and may also optionally further contain a conductive material.

The binder may serve to firmly bind the anode active material particles to each other and to adhere the anode active material to the current collector.

The binder may include styrene-butadiene rubber (SBR), acrylated styrene-butadiene rubber, acrylonitrile-butadiene rubber, acrylic rubber, butyl rubber, ethylene-propylene copolymer, polyepichlorohydrin, polyphosphazene, polyacrylonitrile, polystyrene, ethylene-propylene-diene copolymer, polyvinylpyridine, chlorosulfonated polyethylene, latex, polyester resin, acrylic resin, phenol resin, epoxy resin, polyvinyl alcohol resin, acrylate-based resin, or combinations thereof.

Considering the output characteristics of the lithium secondary battery, the binder content may be less than that of the anode active material. For example, the anode active material and the binder constituting the anode material may be mixed with each other in a ratio of 80 to 99 wt %:1 to 20 wt %.

The anode material may have a thickness of 1 μm to 20 μm, and for example, 5 μm to 15 μm. When the thickness of the anode material is within the above range, the output characteristics of the lithium secondary battery are excellent.

The anode material may be further formulated with additives used in conventional lithium secondary batteries, for example, fillers, coating agents, dispersants, and ion conductive additives, but is not limited thereto.

The anode material may be prepared by coating and drying a slurry in which the above-described anode active material is dispersed on a current collector.

The method for manufacturing a solid superacid-coated anode for a lithium secondary battery according to the present disclosure includes: mixing a zirconium precursor and an anode active material precursor with an organic solvent and then adding distilled water and an acidic solution thereto to perform gelation; drying the gel formed by the gelation; preparing an anode active material by calcining the dried powder, the anode active material including a nano-sized solid superacid coated on a surface thereof, and forming an anode material by applying a slurry for the anode material containing the anode active material to at least one surface of a current collector.

To prepare solid superacid-coated graphite, a sol-gel method, a drying method, and calcination were performed in sequence.

Mixing Zirconium Precursor and Anode Active Material Precursor in Organic Solvent and then Adding Distilled Water and Acidic Solution Thereto to Perform Gelation

A zirconium precursor, anhydrous zirconium n-propoxide, and an anode active material precursor may be mixed in n-propanol as an organic solvent.

Specifically, zirconium propoxide and an anode active material precursor are added to n-propanol, followed by the addition of water and a sulfuric acid solution until a gel is formed.

The organic solvent: the zirconium precursor and the anode active material precursor may be mixed with each other in a weight ratio of 1:0.01 to 0.1. When the mixture is within the above weight range, the dispersibility of the mixture may be improved, which is advantageous for preparing a solid superacid.

The concentration of zirconium in the mixture may be 5 to 10 mmol/L.

When the concentration of zirconium is 5 to 10 mmol/L, it is sufficient for the zirconium surface to be modified with sulfuric acid groups.

The anode active material precursor may include one or more of graphite, hard carbon, activated carbon, carbon nanotubes, carbon nanowires, carbon fibers, carbon black, porous carbon, a pyrolyzed material of cryogel, a pyrolyzed material of xerogel, and a pyrolyzed material of aerogel.

The acidic solution may include a sulfuric acid solution.

During a sol-gel process, the particle size of the solid superacid may be controlled by the concentration of the precursors, the mixing ratio of the anode active material precursor, the acidity (pH), the reaction temperature, etc.

After gelation, a nano-sized solid superacid may be formed on the surface of the anode active material (graphite).

To increase the reactivity of the zirconium precursor, the anode active material precursor, and the sulfuric acid solution, an ultrasonic-assisted mixing step may be performed, but is not limited thereto.

### Drying Gel Formed by Gelation

The prepared gel is subjected to aging at 40 to 60° C., and then dried at 40 to 90° C. for 5 to 24 hours to obtain a dried powder.

By performing aging and drying within the above temperature range, S—ZrO₂ formed on the surface of the carbon-based material, which is the anode active material, attains the desired size and internal porosity.

Hydrolysis proceeds during the aging step, and may be performed for 10 to 120 minutes, but is not limited thereto.

### Preparing Anode Active Material by Calcining Dried Powder, the Anode Active Material Including Nano-Sized Solid Superacid Coated on Surface Thereof

A nano-sized porous solid superacid may be coated on the surface of the anode active material by calcining the dried powder at 500 to 700° C. for 2 to 5 hours.

Calcination is performed to remove the solvent and improve crystallinity.

The solid superacid may be included in an amount of 3 wt % or less, based on 100 wt % of the total amount of the anode active material and the solid superacid. In addition, the solid superacid may have a diameter of 100 nm or less.

The content and diameter of the solid superacid are the same as described above, and thus their description will be omitted.

### Forming Anode Material by Applying Slurry for Anode Material Containing Anode Active Material to at Least One Surface of Current Collector

A binder may be mixed with a solid superacid-coated anode active material, and a conductive material may be further added.

A slurry for an anode material, in which a binder is mixed with the solid superacid-coated anode active material, may be applied to at least one surface of a current collector to form an anode material.

With respect to the binder content, the anode active material and the binder constituting the anode material may be mixed with each other in a ratio of 80 to 90 wt %:10 to 20 wt %.

The slurry for an anode material may include, but is not limited to, an aqueous solvent.

Then, an anode may be manufactured by drying the coated anode material.

The drying process is a process for removing the solvent contained in the anode material.

The drying means is not particularly limited, and conventional drying means may be used. For example, drying may be performed by various drying methods, such as natural drying, heat drying, reduced-pressure drying, and forced-air drying, and may be performed in multiple steps.

The drying process is not particularly limited, but may, for example, be performed within a range of 60 to 180° C., and more preferably 70 to 150° C., for 30 minutes or more, and more preferably 1 to 6 hours.

After the drying process, a rolling process may be performed, whereby the thickness and density of the anode material may be adjusted.

The rolling process may be performed by a conventional method such as a roll press method or a flat press method, whereby the anode material may be prepared to have a thickness of 20 μm or more and 120 μm or less, for example, 40 μm or more and 100 μm or less, or 60 μm or more and 80 μm or less.

The lithium secondary battery according to the present disclosure includes an anode, a cathode, and an electrolyte, wherein the anode includes a current collector, and an anode material disposed on at least one surface of the current collector and including an anode active material, and wherein the anode active material includes a nano-sized solid superacid present on a surface thereof.

The anode is the same as described above. The anode, functionally, may generate and consume electrons by an electrochemical reaction, and serves to deliver electrons to an external circuit through an anode current collector. The anode may reversibly intercalate or deintercalate lithium ions.

The cathode may generate and consume electrons by an electrochemical reaction, and serves to deliver electrons to an external circuit through a cathode current collector.

The cathode is not particularly limited, and may be prepared by applying a slurry for a cathode material to at least one surface of the cathode current collector, followed by drying and rolling to form a cathode material. A cathode commonly used in secondary batteries may be suitably used in the present disclosure.

The slurry for a cathode material contains a cathode active material, a binder, and a solvent, and if desired, may contain a conductive material.

As the cathode active material, a compound capable of reversibly intercalating and deintercalating lithium (a lithiated intercalation compound) may be used. Specifically, one or more composite oxides of lithium and a metal selected from cobalt, manganese, nickel, and combinations thereof may be used. More specific examples include layered lithium-transition metal compounds (oxides) represented by the general formula LiMO₂, where M includes at least one transition metal element such as Ni, Co, and Mn, and may further include other metallic or non-metallic elements. The composite oxides may include, for example, a unary lithium-transition metal complex oxide containing one transition metal element, a so-called binary lithium-transition metal complex oxide containing two transition metal elements, or a ternary lithium-transition metal complex oxide containing the transition metal elements Ni, Co, and Mn as constituent elements. Examples thereof include lithium-transition metal compounds (oxides) represented by the general formula Li₂MO₃, where M includes at least one transition metal element such as Mn, Fe, and Co, and may further include other metallic or non-metallic elements, for examples, Li₂MnO₃, Li₂PtO₃, etc.

Furthermore, a cathode active material having a coating layer on its surface may be used, or a mixture of the compound and a compound having such a coating layer may be used. The coating layer may include at least one coating element compound selected from the group consisting of oxides, hydroxides, oxyhydroxides, oxycarbonates, and hydroxycarbonates of the coating element. The compounds forming the coating layer may be amorphous or crystalline. As the coating elements included in the coating layer, Mg, Al, Co, K, Na, Ca, Si, Ti, V, Sn, Ge, Ga, B, As, Zr, or a mixture thereof may be used.

The binder serves to bind the cathode active material particles to each other, and also to adhere the cathode active material to the cathode current collector.

The binder may be, for example, polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, etc.

The conductive material is used to impart conductivity to the cathode, and any electronically conductive material commonly used in the cathode of a secondary battery may be suitably used.

The solvent may be an aqueous solvent such as water, as well as a non-aqueous solvent. The non-aqueous solvent may be any non-aqueous solvent commonly used in the preparation of a cathode material for a secondary battery, and examples thereof include, but are not limited to, n-methyl-2-pyrrolidone (NMP).

The cathode current collector may be a metal with excellent conductivity, for example, aluminum, nickel, titanium, or stainless steel, and may be in various forms, such as a sheet, foil, or mesh. The thickness of the cathode current collector is not particularly limited, and may be, for example, 5 to 30 μm.

As described above, a cathode in which a cathode material is formed on a cathode current collector may be manufactured by applying a slurry for the cathode material to at least one surface of the cathode current collector, followed by drying and rolling.

For the electrolyte, a non-aqueous electrolyte or a solid electrolyte may be used, and an electrolyte in which a lithium salt is dissolved is used.

The non-aqueous electrolyte may include an organic solvent, and the non-aqueous organic solvent may serve as a medium through which ions involved in the electrochemical reaction of the battery may migrate.

The organic solvent may be, for example, cyclic carbonates such as ethylene carbonate, propylene carbonate, butylene carbonate, and vinylene carbonate; chain carbonates such as dimethyl carbonate, methyl ethyl carbonate, and diethyl carbonate; esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitriles such as acetonitrile; and amides such as dimethylformamide. These solvents may be used alone or in combination of two or more of the aforementioned solvents.

In particular, a mixed solvent of cyclic carbonates and chain carbonates may be preferably used.

In addition, as the electrolyte, a gel polymer electrolyte impregnated with an electrolyte solution in a polymer electrolyte such as polyethylene oxide or polyacrylonitrile may be used, or an inorganic solid electrolyte such as LiI or Li₃N may be used.

The lithium salt is a substance that is dissolved in an organic solvent to server as a source of lithium ions within the battery, enabling the basic operation of the lithium secondary battery and promoting the migration of lithium ions between the cathode and the anode.

The lithium salt may be applied without limitation, as long as it is commonly used in the art and does not depart from the objectives of the present disclosure.

For example, the lithium salt may be one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiCl, and LiI.

Depending on the type of lithium secondary battery, a separator may also be present between the cathode and the anode.

Such a separator may be a multi-layer film comprising two or more layers of polyethylene, polypropylene, polyvinylidene fluoride, or combinations thereof, and may include, for example, a two-layer polyethylene/polypropylene separator, a three-layer polyethylene/polypropylene/polyethylene separator, or a three-layer polypropylene/polyethylene/polypropylene separator.

Lithium secondary batteries may be classified into lithium-ion batteries, lithium-ion polymer batteries, and lithium polymer batteries depending on the type of separator and electrolyte used, may be classified into cylindrical, prismatic, coin-type, pouch-type, etc., depending on the shape, and may be divided into bulk type and thin-film type depending on the size.

The separator is a member interposed between the anode and the cathode to prevent direct contact therebetween and avoid short circuits. The separator not only physically separates the anode and the cathode, but also plays an important role in improving battery stability.

The separator interposed between the cathode and the anode may be a porous sheet, non-woven fabric, etc., and may be a multi-layer film comprising two or more layers of polyethylene, polypropylene, polyvinylidene fluoride, or combinations thereof, for example, a mixed multi-layer film such as a two-layer polyethylene/polypropylene film, a three-layer polyethylene/polypropylene/polyethylene film, or a three-layer polypropylene/polyethylene/polypropylene film. Furthermore, the separator may have a porous heat-resistant layer on one or both sides of the porous sheet, non-woven fabric, etc.

The separator is not particularly limited, but for example, a separator having a thickness of about 10 to 40 μm may be used.

Thus, specific examples regarding the solid superacid-coated anode for a lithium secondary battery, the method for manufacturing the same, and the lithium secondary battery using the same are as follows.

### 1. Manufacture of Anode and Lithium Secondary Battery Using the Same

### Example

N-propanol: zirconium propoxide and graphite were added in a mass ratio of 1:0.01 to 0.10.

Water and sulfuric acid were added until a gel was formed.

This gel was aged at 60° C., and then the remaining water was replaced with alcohol, followed by drying at 50° C.

The dried powder was calcined at 600° C. for 2 hours to prepare a final product, a solid superacid-coated graphite.

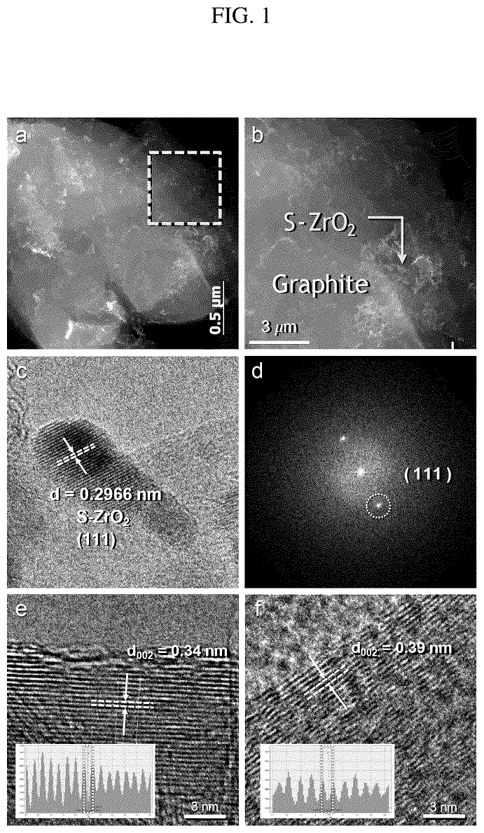

FIG. 1 shows TEM images of graphite coated with 3 wt % of a solid superacid according to the present disclosure.

(a) HR-TEM of graphite not coated with a solid superacid, (b) HR-TEM of graphite coated with 3 wt % of a solid superacid, (c) graphite coated with 3 wt % of a solid superacid, (d) FFT pattern of graphite coated with 3 wt % of a solid superacid, and (e) and (f) STEM of graphite coated with 3 wt % of a solid superacid.

FIG. 1 shows changes in the graphite structure.

The white areas in the graphite coated with 3 wt % of a solid superacid represents the solid superacid, and the interlayer spacing on the graphite surface was 0.2 to 0.4 nm.

Therefore, it can be confirmed from FIG. 1 that solid superacid nanoparticles were formed on the prepared graphite surface.

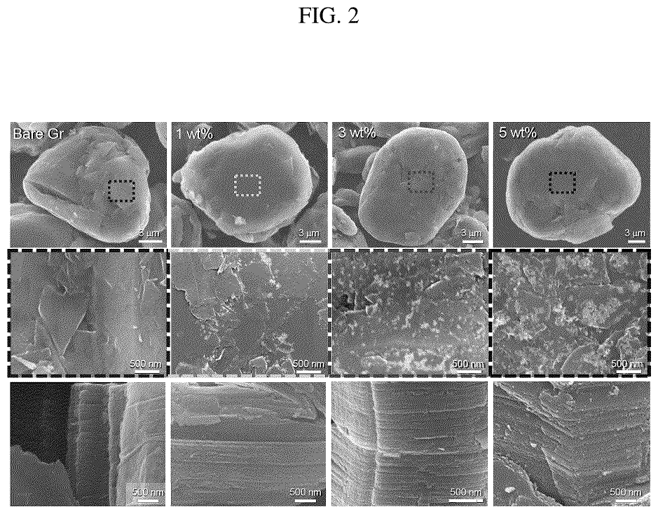

FIG. 2 shows SEM images of graphite not coated with a solid superacid, and graphite coated with 1 wt %, 3 wt %, and 5 wt % of a solid superacid according to the present disclosure.

Compared to the surface of graphite not coated with a solid superacid, the white solid superacid may be confirmed on the graphite surface coated with 1 wt %, 3 wt %, and 5 wt % of a solid superacid.

However, unlike the graphite coated with 1 wt % and 3 wt % of a solid superacid, severe deformation or damage to the edge region was found in the graphite coated with 5 wt %.

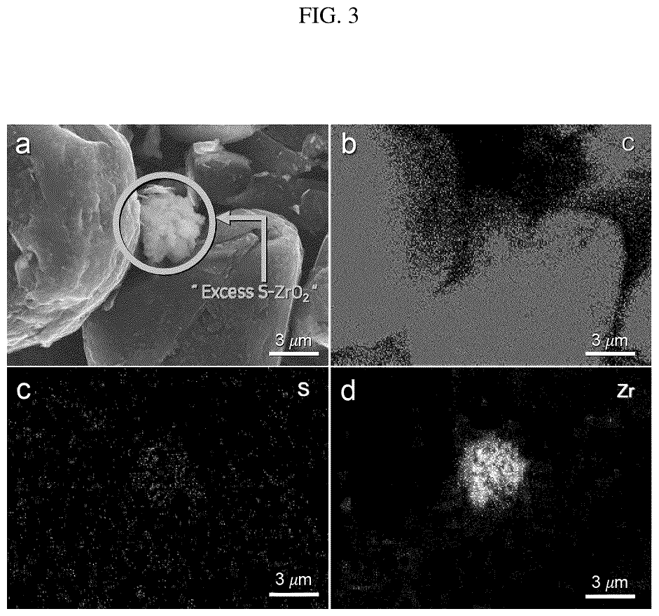

FIG. 3 shows SEM and EDS element mapping images of graphite coated with 5 wt % of a solid superacid according to the present disclosure.

When the solid superacid was excessively coated at approximately 5 wt %, it formed micro-sized particles in regions other than the graphite surface.

These results indicate that coating the graphite surface with the solid superacid at 3 wt % or less is preferred.

To verify the effect of solid superacid-containing graphite, a half cell and a full cell were manufactured. For the full cell, LCO was used as the cathode active material.

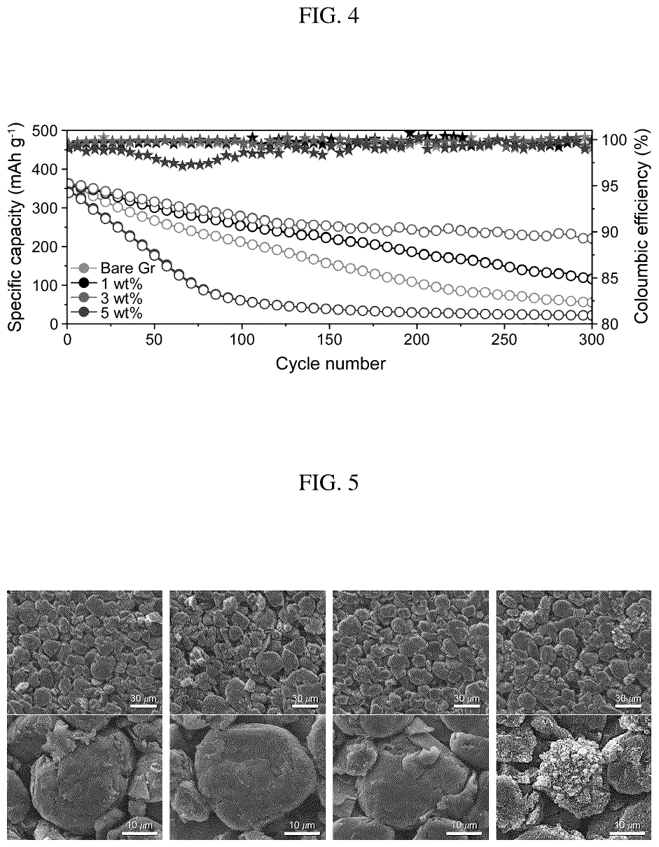

FIG. 4 shows the cycle life performance and coulombic efficiency characteristics for a half-cell in which graphite not coated with a solid superacid is applied (Comparative Example) and half-cells in which graphite coated with 1 wt %, 3 wt %, and 5 wt % of a solid superacid is applied (Examples).

The Examples used graphite coated with 1 wt %, 3 wt %, and 5 wt % a solid superacid as the anode active material.

The Comparative Example used uncoated graphite as the anode active material.

As the electrolyte solution, a mixed solution of 1 M LiPF₆ in EC/EMC 3:7 v/v was used, and as the separator, a PE separator was used.

When charging and discharging were repeated at a rate of 1 C, the Comparative Example exhibited a sharp decrease in capacity as cycling progressed.

In contrast, the Examples were found to exhibit stable cycle life characteristics.

In particular, among the Examples, the Examples using graphite coated with 1 wt % and 3 wt % of a solid superacid exhibited excellent cycle life performance.

FIG. 5 shows SEM images after 150 cycles at a 1 C discharging rate and a 0.5 C charging rate for (b) a half-cell in which graphite not coated with a solid superacid is applied (Comparative Example) and half-cells in which graphite coated with (c) 1 wt %, (d) 3 wt %, and (e) 5 wt % of a solid superacid is applied (Examples).

It can be confirmed that (e) in the half cell in which graphite coated with 5 wt % of a solid superacid is applied, an excessive amount of thick, white electrolyte solution by-products was formed.

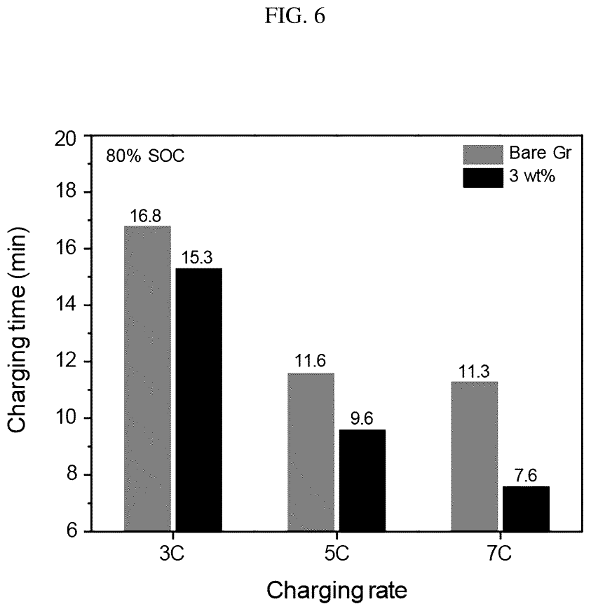

FIG. 6 is a graph comparing the 80% charging time according to the charging rate for a full cell in which graphite not coated with a solid superacid is applied (Comparative Example) and a full cell in which graphite coated with 3 wt % of a solid superacid is applied (Example).

To confirm the effect of solid superacid-coated graphite at a high current density, the 80% charging time according to the charging rate was compared at various current densities.

As a result, the charging time of the Example was shorter than that of the Comparative Example at all current densities.

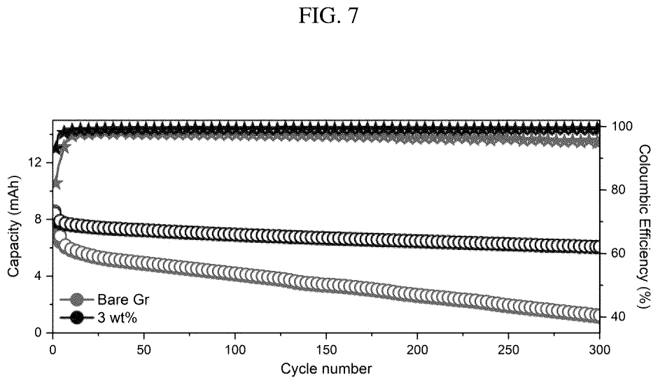

FIG. 7 is a graph comparing the cycle life performance and coulombic efficiency for a full cell in which graphite not coated with a solid superacid is applied (Comparative Example) and a full cell in which graphite coated with 3 wt % of a solid superacid is applied (Example).

To compare long-term cycle life at a high current density, full cell electrochemical tests were conducted at a charging rate of 3 C.

As a result, the Example exhibited excellent cycle life characteristics and coulombic efficiency compared to the Comparative Example.

As such, the present disclosure may utilize an anode active material whose surface is modified with a solid superacid to expand the interlayer spacing of the surface of the anode active material. Accordingly, the mobility of lithium ions may be improved, and intercalation and deintercalation may be facilitated.

In addition, the present disclosure may promote the dissociation of the lithium salt within the electrolyte through a solid superacid coating. By utilizing the catalytic function of the solid superacid, an inorganic-rich SEI may be formed at the interface between graphite and the electrolyte solution, and lithium plating on the anode active material may be prevented.

As a result, the present disclosure may improve the rapid charging characteristics and cycle life characteristics of the lithium secondary battery through the solid superacid coating of the anode active material.

According to the present disclosure, by using a solid superacid-coated anode active material, the mobility of lithium ions at the surface of the anode active material is enhanced, and the formation of a stable SEI layer is induced, thereby improving the electrochemical performance of a lithium secondary battery, including rapid charging characteristics and cycle life stability.

This improves reaction kinetics of lithium ions during charging and expands the interlayer spacing of the surface, including the edge planes, thereby facilitating lithium-ion intercalation/deintercalation.

In addition to the effects described above, the specific effects of the present disclosure are described together with the following detailed description for implementing the present disclosure.

While the present disclosure has been described with reference to the accompanying drawings, it should be understood that the present disclosure is not limited to the embodiments and drawings disclosed herein, and it is obvious that various modifications may be made by those skilled in the art within the scope of the technical idea of the present disclosure. Furthermore, even if the operational effects according to the constitution of the present disclosure have not been explicitly described in the foregoing description of the embodiments of the present disclosure, it is to be understood that predictable effects resulting from such configuration should also be recognized.

What is claimed is:

1. An anode comprising:
a current collector; and
an anode material disposed on at least one surface of the current collector and including an anode active material,
wherein the anode active material includes a nano-sized solid superacid present on a surface thereof.

2. The anode of claim 1 wherein the solid superacid is present on the surface of the anode active material that is in contact with an electrolyte solution.

3. The anode of claim 1, wherein the solid superacid has a porous structure, and includes one or more of sulfated zirconia, sulfated titanium dioxide, sulfated tin dioxide, and sulfated aluminum oxide.

4. The anode of claim 1, wherein the solid superacid is included in an amount of 3 wt % or less, based on 100 wt % of the total amount of the anode active material and the solid superacid.

5. The anode of claim 1, wherein the solid superacid has a diameter of 100 nm or less.

6. The anode of claim 1, wherein the anode active material includes a carbon-based powder.

7. A method for manufacturing an anode, the method comprising:
(a) mixing a zirconium precursor and an anode active material precursor with an organic solvent and then adding distilled water and an acidic solution thereto to perform gelation;
(b) drying the gel formed by the gelation;
(c) preparing an anode active material by calcining the dried powder, the anode active material including a nano-sized solid superacid coated on a surface thereof; and
(d) forming an anode material by applying a slurry for the anode material containing the anode active material to at least one surface of a current collector.

8. The method of claim 7, wherein in step (c), the solid superacid is included in an amount of 3 wt % or less, based on 100 wt % of the total amount of the anode active material and the solid superacid.

9. The method of claim 7, wherein the solid superacid has a diameter of 100 nm or less.

10. The method of claim 7, wherein in step (a), the organic solvent: the zirconium precursor and the anode active material precursor are mixed with each other in a weight ratio of 1:0.01 to 0.1.

11. The method of claim 7, wherein in step (a), the acidic solution includes a sulfuric acid solution.

12. The method of claim 7, wherein in step (c), the calcination is performed at 500 to 700° C. for 2 to 5 hours.

13. The method of claim 7, wherein the anode active material precursor includes one or more of graphite, hard carbon, activated carbon, carbon nanotubes, carbon nanowires, carbon fibers, carbon black, porous carbon, a pyrolyzed material of cryogel, a pyrolyzed material of xerogel, and a pyrolyzed material of aerogel.

14. A lithium secondary battery comprising:
an anode;
a cathode, and
an electrolyte,
wherein the anode includes a current collector, and an anode material disposed on at least one surface of the current collector and including an anode active material, and
wherein the anode active material includes a nano-sized solid superacid present on a surface thereof.
